(19) United States
(12) Patent Application Publication
(10) Pub. No.: US 2020/0168089 A1
(43) Pub. Date: May 28, 2020

(54) SYSTEM AND METHOD FOR IDENTIFYING A PARKING SPACE IN A MULTI-LEVEL PARKING AREA

(71) Applicant: HCL Technologies Limited, Noida (IN)

(72) Inventor: Indrajit Malatesh NADGIR, Bengaluru (IN)

(21) Appl. No.: 16/200,716

(22) Filed: Nov. 27, 2018

(51) Int. Cl. G08G 1/14; H04W 4/46

(52) U.S. Cl. CPC G08G 1/141; H04W 4/46

(57) ABSTRACT

The present disclosure relates to system(s) and method(s) for identifying a parking space in a multi-level parking area. The system receives a request signal from a current vehicle for identifying a parking space in a multi-level parking area. The system further transmits the request signal to one or more vehicles, from a set of vehicles, parked in each RDMN, from a set of RDMNs associated with the multi-level parking area. One or more parking spaces are identified by the one or more vehicles using a sensor mounted in each vehicle. Further, the system selects a target parking space from the one or more parking spaces. Furthermore, the system transmits target data corresponding to the target parking space and a location of target RDMS, associated with the target parking space, to the current vehicle.

### CROSS-REFERENCE TO RELATED APPLICATIONS AND PRIORITY

The present application does not claim priority from any patent application.

### TECHNICAL FIELD

The present disclosure in general relates to the field of vehicle to vehicle communication. More particularly, the present invention relates to a system and method for identifying a parking space in a multi-level parking area.

### BACKGROUND

At times, in a multi-level parking area such as sports arenas, shopping malls, airports and the like, driver fails to find a parking space to park a vehicle. Some techniques are available that includes using sensors or cameras to find a vacant parking space. Also, some techniques maintain a database of vacant parking spaces. In this case, when a vehicle requests for a vacant parking space, the system checks with the database and provides the vacant parking space if available. However, there exists problem of scalability with these available techniques. Further, it is to be noted that a number of autonomous vehicles is increasing day by day. Thus, the size of multi-level parking space may increase in near future. It is to be understood that the available techniques to find the vacant parking space are not scalable.

### SUMMARY

Before the present systems and methods for identifying a parking space in a multi-level parking area, is described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and method for identifying the parking space in the multi-level parking area. This summary is not intended to identify essential features of the claimed subject matter nor is it intended for use in determining or limiting the scope of the claimed subject matter.

In one implementation, a system for identifying a parking space in a multi-level parking area is illustrated. The system comprises a memory and a processor coupled to the memory, further the processor is configured to execute programmed instructions stored in the memory. In one embodiment, the processor may execute programmed instructions stored in the memory for receiving a request signal from a current vehicle to identify a parking space in a multi-level parking area. The multi-level parking area may consist of a set of RDMNs (Route Definition Marked Nodes) and a set of RDMPs (Route Definition Marked Paths) connecting the set of RDMNs. Further, the processor may execute programmed instructions stored in the memory for transmitting the request signal to one or more vehicles, from set of vehicles, parked in each RDMN from the set of RDMNs. The one or more vehicles may be configured to identify one or more parking spaces, associated with each vehicle, from the one or more vehicles. The one or more parking spaces may be identified by the one or more vehicles using a sensor mounted in each vehicle. The processor may further execute the programmed instructions stored in the memory for receiving primary data corresponding to the one or more parking spaces from the one or more vehicles. Further, the processor may execute the programmed instructions stored in the memory for selecting a target parking space, from the one or more parking spaces, based on a location of one or more RDMNs, associated with the one or more parking spaces, and a location of the current vehicle. The processor may execute the programmed instructions stored in the memory for transmitting target data corresponding to a target parking space and a location of a target RDMN, associated with the target parking space, to the current vehicle.

In another implementation, a method for identifying a parking space in a multi-level parking area is illustrated. In one embodiment, the method may comprise receiving a request signal from a current vehicle to identify a parking space in a multi-level parking area. The multi-level parking area may consist of a set of RDMNs (Route Definition Marked Nodes) and a set of RDMPs (Route Definition Marked Paths) connecting the set of RDMNs. Further, the method may comprise transmitting the request signal to one or more vehicles, from set of vehicles, parked in each RDMN from the set of RDMNs. The one or more vehicles may be configured to identify one or more parking spaces, associated with each vehicle, from the one or more vehicles. The one or more parking spaces may be identified by the one or more vehicles using a sensor mounted in each vehicle. The method may further comprise receiving primary data corresponding to the one or more parking spaces from the one or more vehicles. Further, the method may comprise selecting a target parking space, from the one or more parking spaces, based on a location of one or more RDMNs, associated with the one or more parking spaces, and a location of the current vehicle. The method may further comprise transmitting target data corresponding to a target parking space and a location of a target RDMN, associated with the target parking space, to the current vehicle.

In yet another implementation, a computer program product having embodied computer program for identifying a parking space in a multi-level parking area is disclosed. In one embodiment, the program may comprise a program code for receiving a request signal from a current vehicle to identify a parking space in a multi-level parking platform. The multi-level parking area may consist of a set of RDMNs (Route Definition Marked Nodes) and a set of RDMPs (Route Definition Marked Paths) connecting the set of RDMNs. Further, the program may comprise a program code for transmitting the request signal to one or more vehicles, from set of vehicles, parked in each RDMN from the set of RDMNs. The one or more vehicles may be configured to identify one or more parking spaces, associated with each vehicle, from the one or more vehicles. The one or more parking spaces may be identified by the one or more vehicles using a sensor mounted in each vehicle. The program may further comprise a program code for receiving primary data corresponding to the one or more parking spaces from the one or more vehicles. Further, the program may comprise a program code for selecting a target parking space, from the one or more parking spaces, based on a location of one or more RDMNs, associated with the one or more parking spaces, and a location of the current vehicle. The program may further comprise a program code for transmitting target data corresponding to a target parking space and a location of a target RDMN, associated with the target parking space, to the current vehicle.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of system for identifying a parking space in a multi-level parking area, in accordance with an embodiment of the present subject matter.

FIG. 2 illustrates the system for identifying a parking space in a multi-level parking area, in accordance with an embodiment of the present subject matter.

FIG. 3 illustrates a method for identifying a parking space in a multi-level parking area, in accordance with an embodiment of the present subject matter.

### DETAILED DESCRIPTION

Some embodiments of the present disclosure, illustrating all its features, will now be discussed in detail. The words “receiving”, “transmitting”, “selecting”, “identifying” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a”, “an” and “the” include plural references unless the context clearly dictates otherwise. Although any systems and methods similar or equivalent to those described herein can be used in the practice or testing of embodiments of the present disclosure, the exemplary, systems and methods for identifying a parking space in a multi-level parking area are now described. The disclosed embodiments of the system and method for identifying the parking space in the multi-level parking area are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure for identifying a parking space in a multi-level parking area is not intended to be limited to the embodiments illustrated, but is to be accorded the widest scope consistent with the principles and features described herein.

The present subject matter relates to identifying a parking space in a multi-level parking area. In one embodiment, a request signal may be received from a current vehicle. The request signal may be received to identify a parking space in the multi-level parking area. In one embodiment, the multi-level parking area may consist of a set of RDMNs (Route Definition Marked Nodes) and a set of RDMPs (Route Definition Marked Paths) connecting the set of RDMNs. Further, the request signal may be transmitted to one or more vehicles, from a set of vehicles, in each RDMN, from the set of RDMNs. The one or more vehicles may be configured to identify one or more parking spaces, associated with each vehicle. Upon receiving primary data corresponding to the one or more parking spaces from the one or more vehicles, a target parking space, from the one or more parking spaces, may be selection. The target parking space may be selected based on a location of the one or more parking RDMNs, associated with the one or more parking spaces, and a location of the current vehicle. Further, target data corresponding to the target parking space and a location of target RDMN, associated with the target parking space, may be transmitted to the current vehicle.

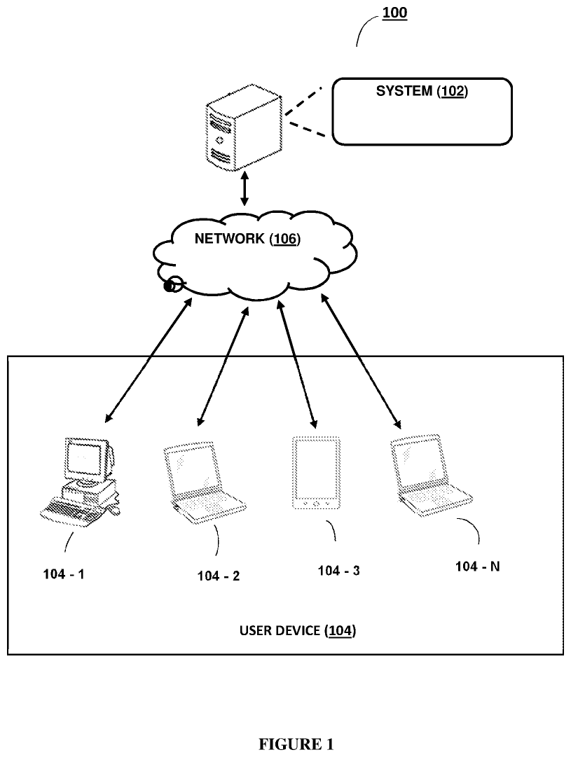

Referring now to FIG. 1, a network implementation 100 of a system 102 for identifying a parking space in a multi-level parking area is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented over a cloud network. Further, it will be understood that the system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the system 102 through a network 106.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

In one embodiment, the system 102 may receive a request signal from a current vehicle. In one aspect, the system 102 may register a vehicle ID, associated with the current vehicle, upon receiving the request signal. The request signal may be received for identifying a parking space in the multi-level parking area. The multi-level parking area may consist of a set of RDMNs (Route Definition Marked Nodes) and a set of RDMPs (Route Definition Marked Paths) connecting the set of RDMNs. In one example, each RDMN, from the set of RDMNs, may comprise a set of parking spaces. Further, a set of vehicles may be parked over the set of parking spaces.

Once the request signal is received, the system 102 may transmit the request signal to one or more vehicles from the set of vehicles. The one or more vehicles may be parked in each RDMN from the set of RDMNs. In one embodiment, the one or more vehicles may be configured to identify one or more parking spaces, associated with each vehicle. The one or more parking spaces may be identified using a sensor mounted in each vehicle. Once the one or more parking spaces are identified, the system 102 may be configured to receive primary data corresponding to the one or more parking spaces from the one or more vehicles.

Further, the system 102 may select a target parking space from the one or more parking spaces. The target parking space may be selected based on a location of each RDMN, associated with the one or more parking spaces, and a location of the current vehicle. In one example, the target parking space may be a parking space that is most convenient for the current vehicle based on the location of the RDMN, associated with the target parking space, and the location of the current vehicle.

The system 102 may further transmit target data to the current vehicle. The target data may correspond to the target parking space and a location of target RDMN, associated with the target parking space. Once the target data is received, the current vehicle may communicate with a vehicle, parked in the target RDMN, using Vehicle to Vehicle communication. Further, the current vehicle may be guided to the target parking space based on the vehicle to vehicle communication.

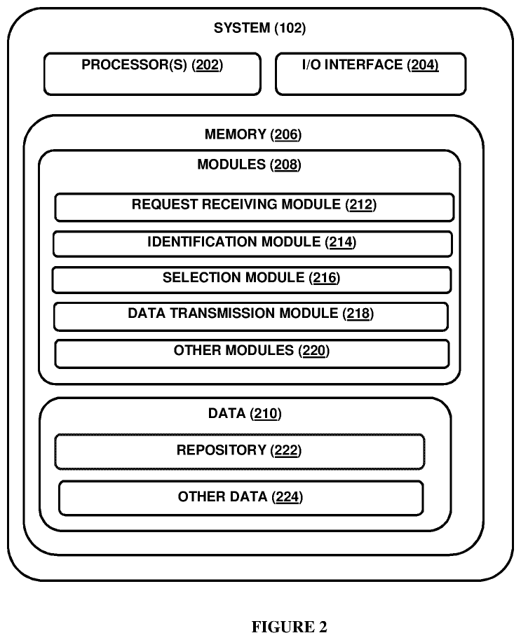

Referring now to FIG. 2, the system 102 for identifying a parking space in a multi-level parking area is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include request receiving module 212, an identification module 214, a selection module 216, data transmission module 218, and other modules 220. The other modules 220 may include programs or coded instructions that supplement applications and functions of the system 102.

The data 210, amongst other things, serve as a repository for storing data processed, received, and generated by one or more of the modules 208. The data 210 may also include a repository 222, and other data 224. In one embodiment, the other data 224 may include data generated as a result of the execution of one or more modules in the other modules 220.

In one implementation, a user may access the system 102 via the I/O interface 204. The user may be registered using the I/O interface 204 in order to use the system 102. In one aspect, the user may access the I/O interface 204 of the system 102 for obtaining information, providing input information or configuring the system 102.

In one embodiment, the request receiving module 212 may receive a request signal from a current vehicle. The request signal may be received to identify a parking space in a multi-level parking area. In one example, if first signal is received from the current vehicle, then the first signal may be considered as the request signal. Once the request signal is received, the request receiving module 212 may register a vehicle ID, associated with the current vehicle. In one example, registration of the vehicle ID, associated with the current vehicle, indicates that the current vehicle will be parked in the multi-level parking area. The current vehicle may be an autonomous vehicle.

In one embodiment, the multi-level parking area may comprise a set of floors. Some examples of the multi-level parking area are parking of sports arena, parking of shopping malls and the like. The multi-level parking area may consist of a set of RDMNs (Route Definition Marked Nodes) and a set of RDMPs (Route Definition Marked Paths). Each RDMP, from the set of RDMPs, may connect one or more RDMN from the set of RDMNs. In one embodiment, the set of RDMNs may comprise a set of parking spaces. Further, a set of vehicles may be parked over the set of parking spaces. Each vehicle, from the set of vehicles, may be an autonomous vehicle.

In one example, each RDMN, from the set of RDMNs, may be a point associated with change in an orientation of vehicles in the multi-level parking area. In other words, each RDMN is a point where vehicle takes left or right or climb a ramp to go to a next floor of the multi-level parking area.

Once the request signal is received, the identification module 214 may check a number of vehicles parked in the set of RDMNs. The number of vehicles may be identified based on a vehicle ID, of each vehicle, from a set of vehicles, registered. In one example, the current vehicle may be a first vehicle to enter the multi-level parking area, when the number of vehicles is zero. In another example, the set of vehicles may be parked in the multi-level parking area, when the number of vehicles is more than or equal to one.

Further, the identification module 214 may transmit the request signal to one or more vehicles, from the set of vehicles, parked in each RDMN. Upon receiving the request signal, the one or more vehicles may be configured to identify one or more parking spaces, associated with each vehicle. The one or more parking spaces may be identified by the one or more vehicles using a sensor mounted in each vehicle. In one embodiment, the one or more vehicles may scan an area around them using the sensors mounted in each vehicle. Based on scanning the area, the one or more parking spaces may be identified by the one or more vehicles. In one example, the one or more parking spaces may correspond to an empty parking spaces in the multi-level parking area.

Once the one or more parking spaces are identified, the identification module 214 may receive primary data from the one or more vehicles. The primary data may correspond to the one or more parking spaces.

In one example, the identification module 214 may not receive any primary data from the one or more vehicles, when there is no parking space is available in the multi-level parking area or the number of vehicles parked in the multi-level parking area is zero.

Upon receiving the primary data, the selection module 216 may select a target parking space from the one or more parking spaces. The target parking space may be selected based on a location of one or more RDMNs, associated with the one or more parking spaces, and a location of the current vehicle. In one aspect, the selection module 216 may measure a distance between the location of one or more RDMNs and the location of current vehicle. Based on the distance, the target parking space may be selected. In another aspect, the target parking space may be selected based on number of turns need to be to reach the location of one or more RDMNs.

In one example, the target parking space may be most convenient parking space for the current vehicle. In another example, the target parking space may be a parking space nearer to the current vehicle. In yet another example, the target parking space may be a parking space for which the current vehicle has to take less number of turns.

In one exemplary embodiment, construe 10 parking spaces are identified by the one or more vehicles parked over a multi-level parking area. The multi-level parking area may comprise 5 entry gates and 5 exit gates. In this case, the selection module 216 may check the location of RDMN, associated with 10 parking spaces, and the location of the current vehicle. The current vehicle may be entering from 3^{rd} entry gate. If the distance between the location of each RDMN, from the 8 RDMNs, associated with 8 parking spaces, and the location of the current vehicle is more as compared to the distance between the location of RDMN, associated with remaining two parking spaces, and the location of the current vehicle. Thus, the selection module 216 may select any one parking space, from remaining two parking spaces, as the target parking space. In this case, the selection module 212 may select the target parking space based on the number of turns to be taken to reach to the target parking space.

Once the target parking space is selected, the transmission module 218 may transmit target data to the current vehicle. The target data may correspond to the target parking space and a location of target RDMN, associated with the target parking space. The target data may also comprise a vehicle ID, associated with a vehicle parked in parking space of target RDMN.

Upon receiving the target data, the current vehicle may be guided to the target parking space by the vehicle, parked in the parking space of the target RDMN. In one embodiment, a Vehicle to Vehicle (V2V) communication may be established between the current vehicle and the vehicle, parked in the parking space of the target RDMN. Based on the V2V communication, the vehicle, parked in the parking space of the target RDMN, may guide the current vehicle to the target parking space. In other words, the vehicle may send a path to the current vehicle to reach to the target parking space. In one aspect, once the current vehicle reaches to the target parking space, the current vehicle may store the path as guided by the vehicle. In one example, the current vehicle may use the path, as stored, for future reference.

In one embodiment, consider that the current vehicle is a first vehicle to enter the multi-level parking area. In this case, the number of vehicles, parked in the multi-level parking area, may be zero. In one aspect, the request receiving module 212 may receive the request signal to identify a parking space. Once the request signal is received, the identification module 214 may check the number of vehicles parked over the multi-level parking area. In one aspect, if the number of vehicles is zero, then the current vehicle may use a dead reckoning system to compute a path to the target parking space, of a target RDMN, associated with the multi-level parking area.

In one aspect, the vehicle ID, associated with the current vehicle, may be delisted, when an exit signal is received from the current vehicle. If a second signal is received from the current vehicle, the second signal may be considered as the exit signal.

Exemplary embodiments discussed above may provide certain advantages. Though not required to practice aspects of the disclosure, these advantages may include those provided by the following features.

Some embodiments of the system and the method is configured to guide a vehicle to a parking space using vehicle to vehicle communication.

Some embodiments of the system and the method is configured to identify the parking space for the vehicle without using a centralised database.

Some embodiments of the system and method is configured to use a dead reckoning system to compute path to the parking space.

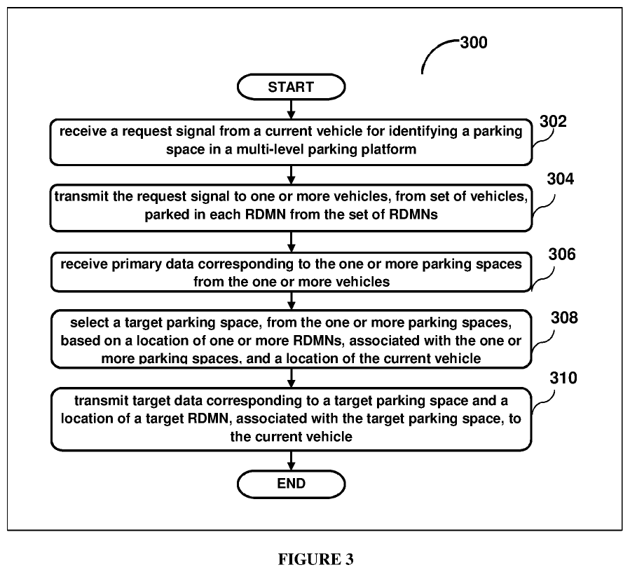

Referring now to FIG. 3, a method 300 for identifying a parking space in a multi-level parking area, is disclosed in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, a request signal may be received from a current vehicle. In one implementation, the request receiving module 212 may receive the request signal from the current vehicle. The request signal may be received for identifying a parking space in a multi-level parking area. In one embodiment, the multi-level parking area may consist of a set of RDMNs (Route Definition Marked Nodes) and a set of RDMPs (Route Definition Marked Paths) connecting the set of RDMNs.

At block 304, the request signal may be transmitted to one or more vehicles, from a set of vehicles, parked in each RDMN. In one implementation, the identification module 214 may transmit the request signal to one or more vehicles, from a set of vehicles, parked in each RDMN. The one or more vehicles may be further configured to identify one or more parking spaces. The one or more parking spaces may be identified by the one or more vehicles using a sensor mounted in each vehicle.

At block 306, primary data may be received from the one or more vehicles. In one implementation, the identification module 214 may receive the primary data from the one or more vehicle. The primary data may correspond to one or more parking spaces.

At block 308, a target parking space may be selected from the one or more parking spaces. In one implementation, the selection module 216 may select the target parking space from the one or more parking spaces. The target parking space may be selected based on a location of one or more RDMNs, associated with the one or more parking spaces, and a location of the current vehicle.

At block 310, target data corresponding to the target parking space and a location of target RDMN, associated with the target parking space, may be transmitted to the current vehicle. In one implantation, the transmission module 218 may transmit the target data to the current vehicle.

Although implementations for systems and methods for identifying a parking space in a multi-level parking area have been described, it is to be understood that the appended claims are not necessarily limited to the specific features or methods described. Rather, the specific features and methods are disclosed as examples of implementations for identifying the parking space in the multi-level parking area.

I/We claim:

1. A system (102) for identifying a parking space in a multi-level parking area, the system comprises
a memory (206);
a processor (202) coupled to the memory (206), wherein the processor (202) is configured to execute programmed instructions stored in the memory (206) to:
receive a request signal from a current vehicle for identifying a parking space in a multi-level parking area, wherein the multi-level parking area consists of a set of RDMNs (Route Definition Marked Nodes) and a set of RDMPs (Route Definition Marked Paths) connecting the set of RDMNs;
transmit the request signal to one or more vehicles, from a set of vehicles, parked in each RDMN from the set of RDMNs, wherein the one or more vehicles are configured to identify one or more parking spaces, associated with each vehicle, from the one or more vehicles, and wherein the one or more parking spaces are identified by the one or more vehicles using a sensor mounted in each vehicle;
receive primary data corresponding to the one or more parking spaces from the one or more vehicles;
select a target parking space, from the one or more parking spaces, based on a location of one or more RDMNs, associated with the one or more parking spaces, and a location of the current vehicle; and
transmit target data corresponding to a target parking space and a location of a target RDMN, associated with the target parking space, to the current vehicle.

2. The system (102) as claimed in claim 1, further configured to guide the current vehicle to the target parking space based on a vehicle to vehicle communication between the current vehicle and a vehicle, parked in the target RDMN.

3. The system (102) as claimed in claim 1, wherein the current vehicle is configured to compute a path to the location of the target RDMN using a dead reckoning system, when a set of parking spaces, associated with the set of RDMNs, are empty.

4. The system (102) as claimed in claim 1, further configured to register a vehicle ID, associated with the current vehicle, upon receiving the request signal.

5. The system (102) as claimed in claim 1, further configured to delist the vehicle ID, associated with the current vehicle, upon receiving an exit signal from the current vehicle.

6. A method for identifying a parking space in a multi-level parking area, the method comprises steps of:
receiving, by a processor (202), a request signal from a current vehicle to identify a parking space in a multi-level parking area, wherein the multi-level parking area consists of a set of RDMNs (Route Definition Marked Nodes) and a set of RDMPs (Route Definition Marked Paths) connecting the set of RDMNs;
transmitting, by the processor (202), the request signal to one or more vehicles, from a set of vehicles, parked in each RDMN from the set of RDMNs, wherein the one or more vehicles are configured to identify one or more parking spaces, associated with each vehicle, from the one or more vehicles, and wherein the one or more parking spaces are identified by the one or more vehicles using a sensor mounted in each vehicle;
receiving, by the processor (202), primary data corresponding to the one or more parking spaces from the one or more vehicles;
selecting, by the processor (202), a target parking space, from the one or more parking spaces, based on a location of one or more RDMNs, associated with the one or more parking spaces, and a location of the current vehicle; and
transmitting, by the processor (202), target data corresponding to a target parking space and a location of a target RDMN, associated with the target parking space, to the current vehicle.

7. The method as claimed in claim 6, further comprises guiding the current vehicle to the target parking space based on a vehicle to vehicle communication between the current vehicle and a vehicle, parked in the target RDMN.

8. The method as claimed in claim 6, wherein the current vehicle is configured to compute a path to the location of the target RDMN using a dead reckoning system, when a set of parking spaces, associated with the set of RDMNs, are empty.

9. The method as claimed in claim 6, further comprises registering a vehicle ID, associated with the current vehicle, upon receiving the request signal.

10. The method as claimed in claim 6, further comprises delisting the vehicle ID, associated with the current vehicle, upon receiving an exit signal from the current vehicle.

11. A computer program product having embodied thereon a computer program for identifying a parking space in a multi-level parking area, the computer program product comprises:
a program code for receiving a request signal from a current vehicle to identify a parking space in a multi-level parking area, wherein the multi-level parking area consists of a set of RDMNs (Route Definition Marked Nodes) and a set of RDMPs (Route Definition Marked Paths) connecting the set of RDMNs;
a program code for transmitting the request signal to one or more vehicles, from a set of vehicles, parked in each RDMN from the set of RDMNs, wherein the one or more vehicles are configured to identify one or more parking spaces, associated with each vehicle, from the one or more vehicles, and wherein the one or more parking spaces are identified by the one or more vehicles using a sensor mounted in each vehicle;
a program code for receiving primary data corresponding to the one or more parking spaces from the one or more vehicles;
a program code for selecting a target parking space, from the one or more parking spaces, based on a location of one or more RDMNs, associated with the one or more parking spaces, and a location of the current vehicle; and
a program code for transmitting target data corresponding to a target parking space and a location of a target RDMN, associated with the target parking space, to the current vehicle.
